(19) United States
(12) Patent Application Publication
(10) Pub. No.: US 2006/0291511 A1
(43) Pub. Date: Dec. 28, 2006

(54) Power control apparatus for a laser module and a method thereof

(76) Inventors: Yu-Pin Lan, Kuei-Shan (TW); Chih-Lun Fan, Jhunan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/453,964

(22) Filed: Jun. 16, 2006

(30) Foreign Application Priority Data
Jun. 24, 2005 (TW) 94121176

(51) Int. Cl. H01S 3/13; H01S 3/00

(52) U.S. Cl. 372/38.01; 372/29.015; 372/38.09

(57) ABSTRACT

A power control apparatus for controlling the output power of a laser module and a method thereof are disclosed. The power control apparatus includes a feedback unit, a digital control unit, and a driving unit. The feedback unit detects the output power of the laser module and generates a corresponding detection signal. The digital control unit receives the detection signal, and compares the detection signal with the operation parameter signal having a temperature compensation effect obtained from the amended parameter table via a looking-up table method so as to output a driving signal to the driving unit. The driving unit drives the laser module according to the driving signal. Thereby, the output power of the laser module is stable and is not affected by the environmental temperature.

### BACKGROUND OF THE INVENTION

1. Field of the Invention

The present invention relates to a power control apparatus. In particular, this invention relates to a power control apparatus of a laser module and a method thereof.

2. Description of the Related Art

The ruby laser was launched in 1960 has started the development of solid-state laser. With the improvement of the laser diode manufacturing technology, the pumping source for the solid-state laser has changed from a flashing light to a high-power laser diode. The merit of using a laser diode as the pumping source is that the laser's wavelength can be controlled within the absorbing bandwidth of the gain medium. Therefore, the output efficiency of the solid-state laser is enhanced and heat accumulation decreases. Utilizing a frequency transformation method of a non-linear crystal outputs a visible laser. Moreover, the transformed output power achieved by using the non-linear transformation method varies according to environmental temperature, mechanism stability and assembly method, etc, and is non-linear. How to stably control the output power of the diode-pumped solid-state laser is a tough issue for the visible diode-pumped solid-state laser using non-linear transformation.

Most of the driving circuits for diode-pumped solid-state lasers are the same as ones for semiconductor laser. An analog circuit is adopted. T.W. patent 225190 disclosed an auto power controller for controlling the optical pickup head of an optical disc drive. An analog circuit is used and includes a detector, a signal source, a comparator, a gain-changeable amplifier, and a driving unit. Because the driving current for diode-pumped solid-state lasers is higher than the driving current of the semiconductor laser, the stability of output power is affected by the heating process of the circuit and the variation due to the electronic elements are heated. If the conventional analog circuit is used to compensate for the temperature, the total circuit becomes complex. If protection and detection can be achieved when the electronic elements are short or opened, the circuit becomes heavy and complicated. Moreover, when the laser is transformed into a visible laser by a non-linear transformation, the output power varies according to the environmental temperature and is non-linear. If the response speed of the circuit is inadequate, the laser power is unstable.

### SUMMARY OF THE INVENTION

One particular aspect of the present invention is to provide a power control apparatus and a method thereof. A digital control method integrated temperature compensation is used for controlling the laser module to output stable power.

The power control apparatus for controlling the output power of a laser module includes a feedback unit for detecting the output power of the laser module and generating a detection signal, and a digital control unit having an amended parameter table and a temperature detector. The amended parameter table records the relation of the operation parameter signals when the laser module is operating under different temperatures. The digital control unit receives the detection signal and obtains the corresponding operation parameter signal from the amended parameter table via a looking-up table method according to a temperature value obtained by the temperature detector. Then, the detection signal is compared with the operation parameter signal so as to output a driving signal. The power control apparatus also includes a driving unit for receiving the driving signal output from the digital control unit to drive the laser module. Therefore, when the detection signal is larger than the operation parameter signal from the amended parameter table, the digital control unit lowers the driving signal. When the detection signal is smaller than the operation parameter signal from the amended parameter table, the digital control unit increases the driving signal.

The present invention also provides a power control method used for controlling the output power of a laser module. Firstly, the output power of the laser module is detected and a corresponding detection signal is generated. A digital control unit having an amended parameter table is provided. The amended parameter table records the relation of the operation parameter signals when the laser module is operated under different temperatures. The environmental temperature is detected to generate a corresponding temperature value. The digital control unit obtains the corresponding operation parameter signal from the amended parameter table via a looking-up table method according to the temperature value. Then, the digital control unit compares the detection signal with the operation parameter signal from the amended parameter table so as to output a driving signal. Finally, the driving signal is output to the laser module.

By using the power control apparatus and the method thereof of the resent invention, the temperature compensation is implemented by a digital control method that doesn't require a complex analog circuit. Thereby, the output power of the laser module is stabilized and is not affected by the environmental temperature.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a circuit block diagram of a preferred embodiment of the present invention;

FIG. 2 is a circuit diagram of the present invention; and

FIG. 3 is an operation flow chart of a preferred embodiment of the present invention.

### DETAILED DESCRIPTION OF THE PREFERRED EMBODIMENTS

The present invention provides a power control apparatus for controlling the output power of a laser module. In this embodiment, a diode-pumped solid-state laser is used for illustrating the present invention. The laser module is not restricted to the diode-pumped solid-state laser and it may be applied to any laser. In the prior art, an analog method is adopted to control the power of the laser diode. However, the output power of the diode-pumped solid-state laser is easily affected by the environmental temperature and is unstable. In this embodiment, a digital method is adopted to control the output power of the solid-state laser.

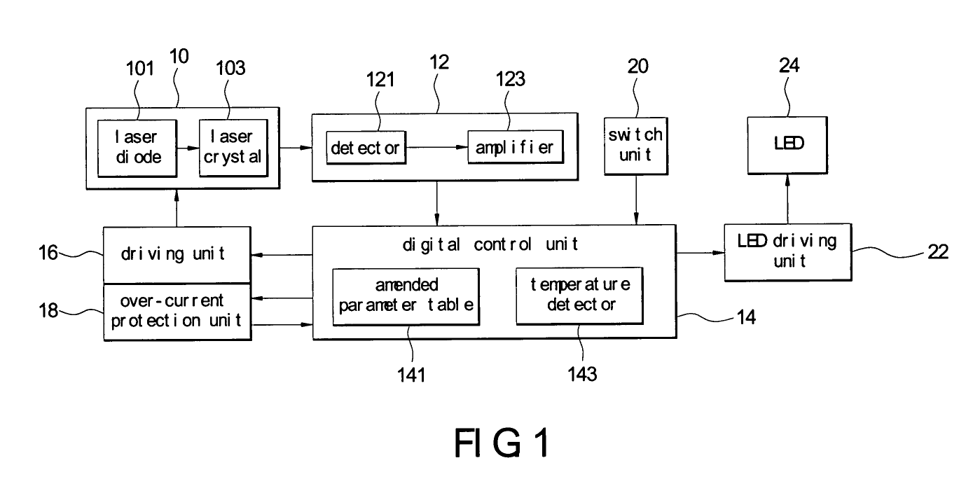

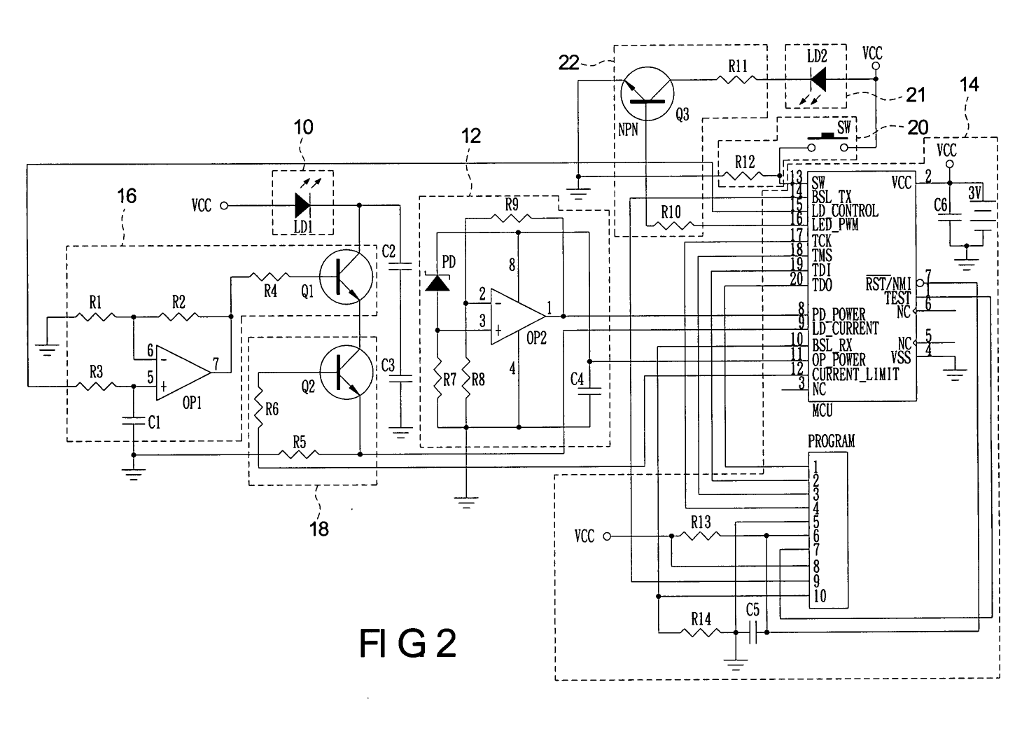

Reference is made to FIG. 1 and FIG. 2. A laser electronic apparatus includes a diode-pumped solid-state laser 10, a feedback unit 12, a digital control unit 14, a driving unit 16, an over-current protection unit 18, a switch unit 20, an LED driving unit 22, and an LED 24. The feedback unit 12, the digital control unit 14, the driving unit 16, and the over-current protection unit 18 are used for controlling the output power of the diode-pumped solid-state laser 10. The switch unit 20 is used for turning on or turning off the diode-pumped solid-state laser 10. The LED driving unit 22 and the LED 24 are used for indicating whether the diode-pumped solid-state laser 10 is turned on or not. For example, the diode-pumped solid-state laser 10 is turned on when the LED 24 is shining. The solid-state laser 10 includes a laser diode 101 and a laser crystal 103. The laser diode 101 is used as the pumping source for the laser crystal 103.

In this embodiment, how to control the output power of the diode-pumped solid-state laser 10 is described. The feedback unit 12 detects the output power of the diode-pumped solid-state laser 10 and outputs a corresponding detection signal to the digital control unit 14. The feedback unit 12 includes a detector 121 and an amplifier 123. The detector 121 detects the output brightness of the diode-pumped solid-state laser 10 to obtain the output power of the diode-pumped solid-state laser 10. The detector can be a photo detector. Then, the amplifier 123 amplifies the detection result of the detector 121 to obtain the detection signal and the detection signal is output to the digital control unit 14.

The digital control unit 14 receives the detection signal output from the feedback unit 12 and compares the detection signal with an operation parameter signal so as to output a driving signal to the driving unit 16. In this embodiment, the operation parameter signal is not fixed. It can be adjustable according to variations in the environmental temperature. In order to achieve this function, the digital control unit 14 includes an amended parameter table 141 and a temperature detector 143. In order to make the output power stable when the diode-pumped solid-state laser 10 is operated under different temperatures, the amended parameter table 141 records the relation of the operation parameter signals when the diode-pumped solid-state laser 10 is operated under different temperatures. The operation parameter signals include a start-up current output parameter and a power parameter when the diode-pumped solid-state laser 10 is operated under different temperatures. In this embodiment, the temperature detector 143 is used for detecting the environmental temperature to obtain a temperature value. The digital control unit 14 can be a microprocessor, a micro-controller, a digital signal processor (DSP), an ASIC, or a programmable logic circuit. The temperature detector 143 can be a built-in the digital control unit 14, or is connected with the digital control unit 14 via an external connection method.

When the digital control unit 14 compares the detection signal with the operation parameter signal, the temperature detector 143 detects the environmental temperature to obtain the temperature value. Then, a corresponding operation parameter signal is obtained from the amended parameter table 141 via a looking-up table method according to the temperature value. Finally, the detection signal is compared with the operation parameter signal. When the detection signal is larger than the operation parameter signal from the amended parameter table, the digital control unit lowers the driving signal to decrease the output power of the diode-pumped solid-state laser 10. When the detection signal is smaller than the operation parameter signal from the amended parameter table, the digital control unit increases the driving signal to increase the output power of the diode-pumped solid-state laser 10. Because the digital control unit 14 always receives the detection signal output from the feedback unit 12 and compares the detection signal with the operation parameter signal from the amended parameter table, the driving signal is always amended to make the output power of the diode-pumped solid-state laser 10 stable.

The driving unit 16 receives the driving signal output from the digital control unit to drive the diode-pumped solid-state laser 10. In this embodiment, the driving unit 16 is a current driving unit. Therefore, when the digital control unit 14 increases the driving current, the output power of the diode-pumped solid-state laser 10 is increased. When the digital control unit 14 decreases the driving current, the output power of the diode-pumped solid-state laser 10 is lowered. For protecting the circuit, because the operation current of the laser diode 101 of the diode-pumped solid-state laser 10 is larger, the over-current protection unit 18 detects the operation current of the laser diode 101 and outputs to the digital control unit 14, and the digital control unit 14 compares the operation current of the laser diode 101 with a pre-determined value. When the operation current of the laser diode 101 is larger than the pre-determined value, the digital control unit 14 outputs a signal to control the over-current protection unit 18 to cut off the operation current of the laser diode 101.

In the starting-up control of the diode-pumped solid-state laser 10, when the digital control unit 14 detects that the switch unit 20 has been pressed, a pre-determined driving signal is output to the driving unit 16 to control the starting-up of the diode-pumped solid-state laser 10. When the diode-pumped solid-state laser 10 is turned on, the output power of the diode-pumped solid-state laser 10 is controlled in the manner described above and the digital control unit 14 also outputs a signal to the LED driving unit 22 to make the LED driving unit 22 control the LED 24 to shine. Thereby, it is indicated that the diode-pumped solid-state laser 10 is turned on.

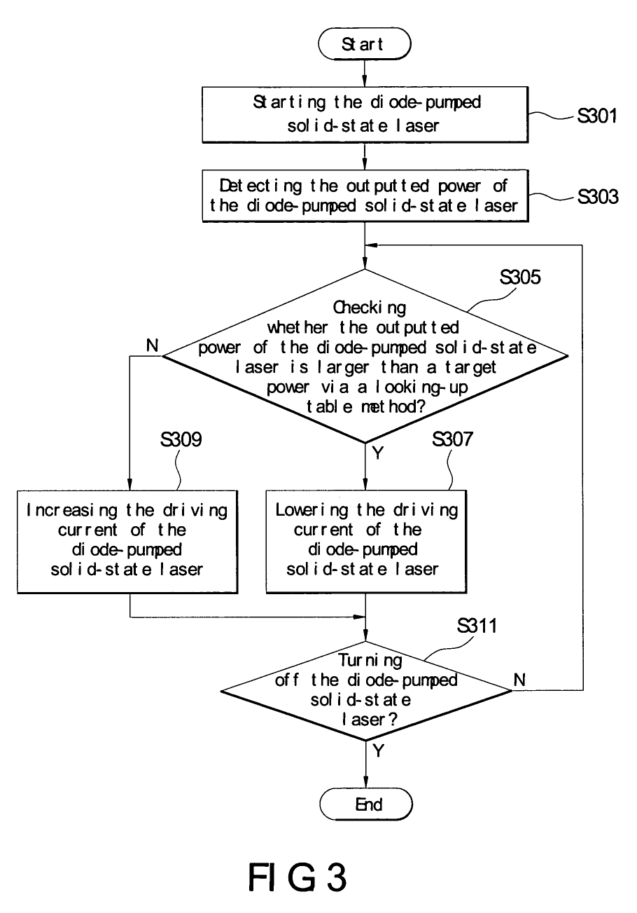

FIG. 3 shows an operation flow chart of a preferred embodiment of the present invention. Firstly, the switch unit 20 is pressed to turn on the diode-pumped solid-state laser 10 (S301). Then, the feedback unit 12 detects the output power of the diode-pumped solid-state laser 10 (S303). The digital control unit 14 checks whether the output power of the diode-pumped solid-state laser 10 is larger than a target power via a looking-up table method (S305). In step 305, the temperature detector 143 detects the environmental temperature to obtain a temperature value and obtains the corresponding operation parameter signal via a looking-up table method according to the temperature value. This operation parameter signal is the target power for comparing with the detection signal.

In step S305, if the compared result is yes, this means that the output power of the diode-pumped solid-state laser 10 is over the target power. The digital control unit 14 therefore lowers the driving signal. In this embodiment, the lowering of the driving signal is implemented by lowering the driving current of the diode-pumped solid-state laser 10 (S307). If the compared result is no, this means that the output power of the diode-pumped solid-state laser 10 is under the target power. The digital control unit 14 therefore increases the driving signal. In this embodiment, increasing the driving signal is implemented by increasing the driving current of the diode-pumped solid-state laser 10 (S309). Finally, whether the switch unit 20 is pressed to turn off the diode-pumped solid-state laser 10 or not is determined (S311). If the determined result is no, S305 is repeated. If the determined result is yes, the method ends.

The power control apparatus of a laser module and a method thereof control the output power of the laser module by a digital method, and has the function of temperature compensation. It adjusts the driving current of the laser diode of the laser module according to the environmental temperature. Most importantly, when the power control apparatus of the present invention is applied to a diode-pumped solid-state laser, the output power of the diode-pumped solid-state laser is stable and the operation temperature range of the power control apparatus is also enlarged.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A power control apparatus used for controlling the output power of a laser module, comprising:
a feedback unit for detecting the output power of the laser module and generating a detection signal,
a digital control unit having an amended parameter table and a temperature detector, wherein the amended parameter table records the relation of the operation parameter signals when the laser module is operated under different temperatures, the digital control unit is used for receiving the detection signal and obtaining the corresponding operation parameter signal from the amended parameter table via a looking-up table method according to a temperature value obtained by the temperature detector and compares the detection signal with the operation parameter signal so as to output a driving signal; and
a driving unit for receiving the driving signal output from the digital control unit to driving the laser module;
wherein, when the detection signal is larger than the operation parameter signal from the amended parameter table, the digital control unit lowers the driving signal, and when the detection signal is smaller than the operation parameter signal from the amended parameter table, the digital control unit increases the driving signal.

2. The power control apparatus as claimed in claim 1, wherein the. feedback unit comprises:
a detector for detecting the output power of the laser module; and
an amplifier for amplifying the detection result from the detector to obtain the detection signal.

3. The power control apparatus as claimed in claim 2, wherein the detector is a photo detector.

4. The power control apparatus as claimed in claim 1, wherein the operation parameter signals include a start-up current output parameter and a power parameter when the diode-pumped solid-state laser is operated under different temperatures.

5. The power control apparatus as claimed in claim 1, wherein the digital control unit is a microprocessor, a micro-controller, a digital signal processor (DSP), an ASIC, or a programmable logic circuit.

6. The power control apparatus as claimed in claim 1, wherein the driving unit is a current driving unit.

7. The power control apparatus as claimed in claim 1, further comprising:
an over-current protection unit for detecting an operation current of the laser module and outputting the operation current of the laser module to the digital control unit, wherein the digital control unit determines whether the operation current of the laser module is larger than a pre-determined value or not to cut off the operation current of the laser module.

8. The power control apparatus as claimed in claim 1, wherein the laser module is a diode-pumped solid-state laser.

9. A power control method used for controlling the output power of a laser module, comprising:
detecting the output power of the laser module and generating a corresponding detection signal
providing a digital control unit having an amended parameter table, wherein the amended parameter table records the relation of the operation parameter signals when the laser module is operated under different temperatures;
detecting the environmental temperature to generate a corresponding temperature value;
obtaining a corresponding operation parameter signal from the amended parameter table via a looking-up table method according to the temperature value via the digital control unit;
comparing the detection signal with the operation parameter signal from the amended parameter table so as to output a driving signal via the digital control unit; and
outputting the driving signal to the laser module.

10. The power control method as claimed in claim 9, wherein the step of detecting the output power of the laser module detects the laser module via a photo detector, and the detection result is amplified to obtain the detection signal.

11. The power control method as claimed in claim 9, wherein the digital control unit is a microprocessor, a micro-controller, a digital signal processor (DSP), an ASIC, or a programmable logic circuit.

12. The power control method as claimed in claim 9, wherein the operation parameter signals include a start-up current output parameter and a power parameter when the diode-pumped solid-state laser is operated under different temperatures.

13. The power control method as claimed in claim 9, wherein the digital control unit comprises a temperature detector for detecting the environmental temperature and generating the corresponding temperature value.

14. The power control method as claimed in claim 9, wherein the step of comparing the detection signal with the operation parameter signal from the amended parameter table via the digital control unit, and when the detection signal is larger than the operation parameter signal from the amended parameter table, the digital control unit lowers the driving signal, and when the detection signal is smaller than the operation parameter signal from the amended parameter table, the digital control unit increases the driving signal.

15. The power control method as claimed in claim 9, wherein the driving signal is a current driving signal.

16. The power control method as claimed in claim 9, further comprising:
determining whether the operation current of the laser module is larger than a pre-determined value via the digital control unit, wherein if the result is yes, the digital control unit cuts off the operation current of the laser module.

17. The power control method as claimed in claim 9, wherein the laser module is a diode-pumped solid-state laser.
